(19) United States
(12) Patent Application Publication
(10) Pub. No.: US 2015/0127624 A1
(43) Pub. Date: May 7, 2015

(54) FRAMEWORK FOR REMOVING NON-AUTHORED CONTENT DOCUMENTS FROM AN AUTHORED-CONTENT DATABASE

(71) Applicant: Google Inc., Mountain View, CA (US)

(72) Inventors: Samuel Wintermute, San Francisco, CA (US); Rohit Ramesh Saboo, Mountain View, CA (US)

(73) Assignee: Google Inc., Mountain View, CA (US)

(21) Appl. No.: 14/070,388

(22) Filed: Nov. 1, 2013

(51) Int. Cl. G06F 17/30

(52) U.S. Cl. CPC G06F 17/30011; G06F 17/30312
USPC 707/696

(57) ABSTRACT

The specification relates to framework for removing non-authored content documents from an authored-content database by recording a sequence of authorship data for at least one authored-content document over a period of time. The at least one authored-content document can be indexed in an authored-content database. The sequence of authorship data is analyzed to determine if the at least one authored-content document changed in a meaningful way beyond a set threshold. If the at least one authored-content document is changed beyond the set threshold, the at least one authored-content document is removed from the authored-content database.

### BACKGROUND

The subject matter described herein relates to maintaining an authored-content database.

Search systems utilize indexes for the searching of web documents. In some search systems, the indexes can identify authored content. Many techniques for identifying authored content are not reliable, for example, because many types of authored content don't have many words, e.g., a short blog post or an original photograph. Additionally, many types of authored content are generated by multiple co-authors.

### SUMMARY

Documents are crawled and processed to identify documents containing authored content. Once an authored-content document is identified, the authored-content document can be further processed to obtain authorship data, e.g., the author's or authors' name(s), links to social profiles or a location of the names on the document. The authorship data can be indexed in an authored-content database along with other identifying information related to the authored-content document.

The authorship data for each indexed authored-content document can be updated over a period of time by crawling the authored-content page as it exists on the Internet. This updating process builds an authorship-data history with successive entries in the history for each document. The authorship-data history for each document can be examined to determine whether a change in authorship data has occurred during a specified period of time. If it has been determined that a document has authorship-data changes beyond a predetermined threshold within the specified period of time, e.g., more than two changes within a week, it can be identified as a non-authored-content document, i.e., a document that does not contain authored content. This non-authored-content document can be removed or blacklisted from the authored-content database and would no longer appear as a result in a search of the authored-content database.

In one implementation, the methods comprise the steps of: recording a sequence of authorship data for at least one authored-content document over a period of time, the at least one authored-content document being indexed in an authored-content database; analyzing the sequence of authorship data to determine if the at least one authored-content document changed beyond a set threshold; removing the at least one authored-content document from the authored-content database if the at least one authored-content document is changed beyond the set threshold.

The method can also include comparing a first data set of the sequence of authorship data to a second data set of the sequence of authorship data; and quantifying data changes between the first data set and the second data set. The method can also include applying the quantified data changes to the set threshold. In some implementations, the set threshold can be three or more changes within a defined time period. In some implementations, the sequence of authorship data can include at least one author name and information relating to a location of an author profile page.

The method can also include indexing the at least one authored-content document for the authored-content database. In some implementations, the period of time can be once a day for a month.

In another implementation, a system can comprise one or more processors and one or more computer-readable storage mediums containing instructions configured to cause the one or more processors to perform operations. The operations can include: recording a sequence of authorship data for at least one authored-content document over a period of time, the at least one authored-content document being indexed in an authored-content database; analyzing the sequence of authorship data to determine if the at least one authored-content document changed beyond a set threshold; removing the at least one authored-content document from the authored-content database if the at least one authored-content document is changed beyond the set threshold.

In another implementation, a computer-program product can be tangibly embodied in a machine-readable storage medium and include instructions configured to cause a data processing apparatus to: record a sequence of authorship data for at least one authored-content document over a period of time, the at least one authored-content document being indexed in an authored-content database; analyze the sequence of authorship data to determine if the at least one authored-content document changed beyond a set threshold; remove the at least one authored-content document from the authored-content database if the at least one authored-content document is changed beyond the set threshold.

The framework can detect documents with authorship changes above a certain threshold so as to identify the document as a non-authored-content document and stop the document from appearing in search results when a user is searching for authored-content documents. This makes for better and more accurate search results. This method is also automated and can be scaled to the entire Internet.

### BRIEF DESCRIPTION OF THE DRAWINGS

FIG. 1 is a block diagram of an example of a communication network used with the disclosed technology;

FIG. 2 is a flow chart showing an example process of removing non-authored content documents from an authored-content database; and

FIG. 3 is a block diagram of an example of an indexing and searching environment used with the disclosed technology.

### DETAILED DESCRIPTION

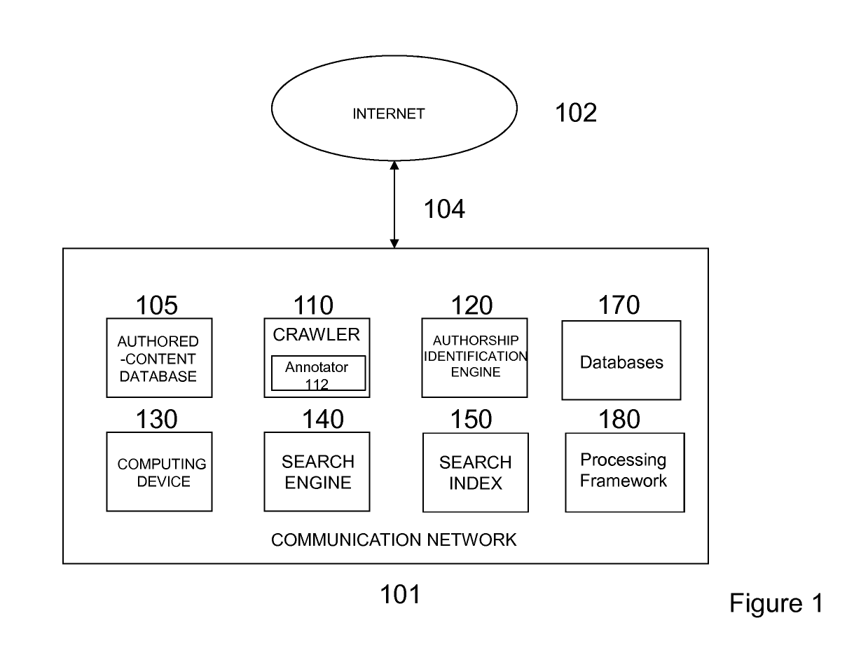

FIG. 1 illustrates a block diagram of an example environment for crawling, indexing and searching Internet content, e.g. Internet documents. The communication network 101 facilitates communication between the various components in the environment. In some implementations, the communication network 101 can include the Internet 102, one or more intranets, or one or more bus subsystems. The communication network 101 can optionally utilize one or more standard communications technologies, protocols, or inter-process communication techniques 104. The example environment also includes a crawler 110, a computing device 130, an authorship identification engine 120, a search engine 140, a search index 150 and an authored-content database 105.

The crawler 110 can be utilized to crawl one or more documents on the Internet 102 via the network 101. A document is any data that is associated with a document address. Documents include HTML pages, word processing documents, portable document format (PDF) documents, images, video, and feed sources, to name just a few. The documents can include content such as, for example: words, phrases, picture; embedded information, such as, meta information or hyperlinks; and embedded instructions, such as, JavaScript scripts.

In some implementations, the crawler 110 can step through the documents in a list, analyze the contents of each document in the list, and optionally identify links to other documents in one or more documents in the list. The crawler 110 can also optionally make requests to any linked-to documents and repeat the analysis and linking process with such linked-to documents. The crawler 110 can also optionally store a list of all documents it has accessed so that it does not make repeated access to a document that is linked to from multiple locations.

In some implementations, the crawler 110 can crawl one or more documents as part of a periodic crawling process for the documents. For example, documents can be periodically crawled based at least in part on popularity or an update frequency of those documents or of other documents that link-to those documents. In some implementations, the crawler 110 can additionally or alternatively crawl one or more documents in response to an on-demand indexing request from an owner of the documents or other interested party.

In some implementations, the crawler 110 can traverse documents accessible via the network 101, analyze the content of the documents, or index some of the content of the documents in a search index 150. This indexing can be performed using conventional techniques and the search index 150 can be accessed by a search engine 140 also using conventional techniques.

In some implementations, an authorship identification engine 120 can be in communication with crawler 110 via network 101. The authorship identification engine 120 can receive identifying information of one or more of the documents or published data indicative of crawled content of the document directly from the crawler 110 and one or more intermediary servers. The data provided by the crawler 110 that is indicative of one or more of the documents can include, for example, a document address such as a URL or other identifiers of the document. The published data provided by the crawler 110 that is indicative of crawled content of one or more of the documents can include, for example, the entirety of the content of a document, one or more portions of content from the document, a hash of the entirety of the content, or a hash of one or more portions of the content. For example, the crawler 110 can provide at least some structured data of the document, a property of the document, a content token that is embedded in the document, a hash of at least some of the document, or one or more aspects of the document that would be provided when the document is retrieved.

In some implementations, the crawler 110 sends the identifying information of one or more of the documents or published data indicative of crawled content of the document to one or more databases 170. The authorship identification engine 120 retrieves the respective data from the one or more databases 170. In some implementations, all or some of the aspects of the authorship identification engine 120 and crawler 110 can be combined as part of a single system.

In some implementations, the crawled documents can be identified as an authored-content document by the authorship identification engine 120 and indexed in an authored-content database 105. An authored-content document is any document that contains authored content, e.g., news articles, blog posts and any other document containing content that an author claimed authorship. In some implementations, an author can claim authorship to the authored-content document by tying all of the author's work to a social profile. For example, the social profile can have a link pointing to the pages or websites that host the author's content or the pages or websites can link back to the author's social profile. An author can also claim authorship by inserting a tag, e.g. <rel=“author” link”>, into the authored-content document. The information indexed in the authored-content database is public information in which the author has published identifying information on a public website or added public attributes to a social profile page linked to the author.

In some implementations, the authorship identification engine 120 can utilize a set of processes to analyze the identifying information extracted by the crawler to identify authored-content documents. For example, the authorship identification engine 120 can search the identifying information for specific features, e.g., a byline phrase like “by firstname lastname,” a name enclosed by tags that might indicate an author, a link to an onsite or social network profile page with appropriate markup (e.g., rel=me or rel=author), a chain of such profile links that lead to a page from which an author can be ascertained and other indicators that differentiate an authored-content document from other web documents. In other words, the extracted information can be provided to an authorship identification engine 120 to enable the authorship identification engine 120 to identify an authored-content document. For example, a document can have a link for the text “by jdoe2321”, which connects to a page showing other works by the user jdoe2321, and this user page can also link in an appropriate way to a social profile page for John Doe. This chain of links can be used to infer that the original article was written by John Doe.

In another implementation, the authorship identification engine 120 can extract information, e.g. annotations, from the document and apply the extracted information to the authorship identification engine 120. An annotation can be metadata, e.g. a comment, explanation, presentational markup, attached to text, image, or other data. Often annotations refer to a specific part of the document. The authorship identification engine 120 can vote on which annotations are likely to indicate an author for the document. The annotations that win the voting process are deemed to indicate the author. The authored-content documents can be processed and indexed in a partitioned portion of search engine and presented differently during searches, e.g., an author-only search which returns a results page with only authored-content documents.

Once identified as an authored-content document, the authored-content documents can be indexed in one or more databases, such as, for example, the authored-content database 105. The authored-content database 105 can be partitioned from the search index 150 or it can be its own index or it can be part of some other search indices. In some implementations, the authored-content database 105 can be directly or indirectly coupled to the crawler 110 or the authorship identification engine 120.

In some instances, the authorship identification engine 120 can incorrectly identify an Internet document as an authored-content document when presented with a non-authored-content document that resembles an authored-content document. These resemblance documents resemble authored-content documents because they have signals similar to an authored-content document but do not contain authored content, e.g., a front page of a news website that has links to authored content but should not be considered authored content itself or the annotators mistakenly determine that the comment section or a “related articles” sidebar of a document contains authored content. These resemblance documents often present similar signals to those presented by the content itself and therefore make it difficult to differentiate a resemblance document from an authored-content document. For instance, both have occurrences of byline phrases like “by Firstname Lastname,” and both can have links to profile pages for authors.

In one implementation, the framework 101 leverages that resemblance documents frequently change what content they point to, so they can be differentiated from authored-content documents by detecting changes in the authors that are indicated. For example, many documents have comments sections or changing ads that are on occasion mistaken as authored content but since the encoding of these sections change on a regular basis it can be differentiated from authored-content documents that change very little over time.

In one example, the crawler 110 can access one or more documents in a list, e.g., the list can be all documents indexed within the authored-content database 105. This crawling can be performed over a period of time, e.g., once a day for a month or once a week for six months. This crawling access can be limited in scope so that the crawler 110 can extract information related to the set of authors for each document within the list along with meta-information about how those authors appeared on the document and social profiles linked to the author. For each accessed document, a data structure called an authorship history is maintained in the authored-content database. The authorship history can be a sequence of authorship data changes in the document over time.

The history of each document can be examined by comparing successive entries in the history to determine whether a change in authorship could have occurred, e.g., the author's name changed or the profile link for the author changed. If a document shows authorship changes beyond a certain threshold, it is judged to be a non-authored-content document, and is prevented from being shown as authored-content in the authored-content database, e.g., the non-authored-content document is removed from the authored-content database or blacklisted within the authored-content database. The above technique relies on detecting changes in a given document over time and focuses on only those changes that are specifically meaningful for the distinction between authored content and non-authored content. For example, the comparison can use the stored identifying information to eliminate spurious change detection due to circumstances like where an intermediate link in a chain needed for verification goes missing, e.g., jdoe2321 removes the link to his social profile page from his user page. Or disregard changes that do not change authorship data for the document, e.g., many documents have comment sections or changing ads that cause the text encoding the document to change, but does not change the authorship data.

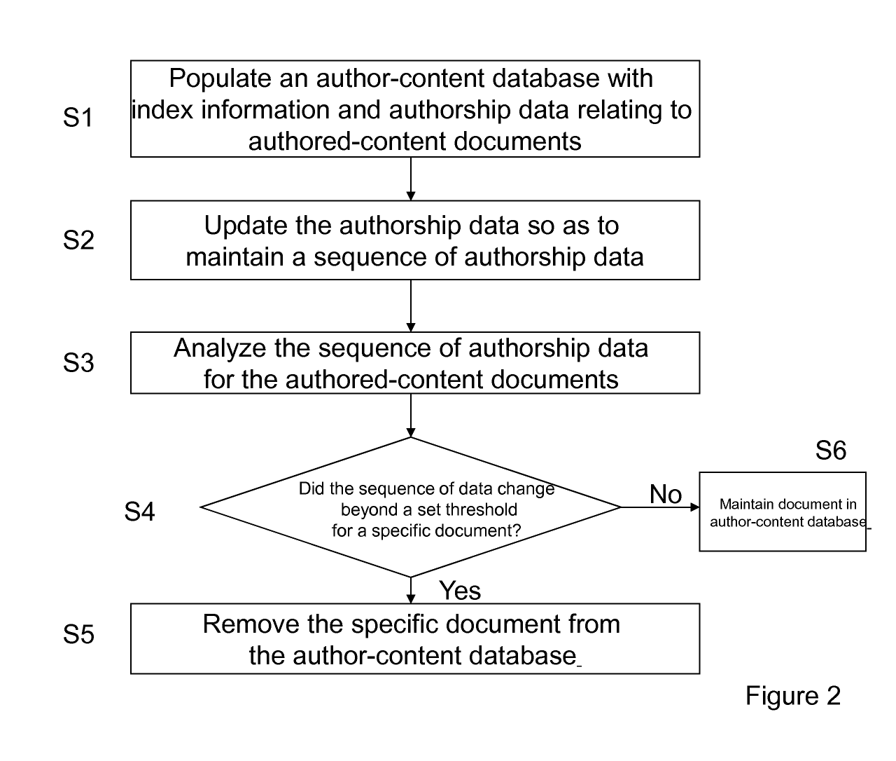

In another example, as shown in FIG. 2, an authored-content database 105 is populated with index information relating to authored-content documents. Step S1. These documents are indexed with authorship data. The authorship data includes, among other things, the names of the authors of the authored content, the way in which the authors' names appear on the document and links to social profiles. Using a crawler 110, the indexed documents, are crawled over time, e.g., once a day for a month, and authorship data is updated in the index so that sequences of authorship data are maintained for every document contained in the database 105. Step S2. Periodically, a sequence of authorship data is analyzed (Step S3), the sequence can be a specific block of time, e.g., a week, a month, etc. An analysis is made to determine if any of the authored-content documents changed beyond a set threshold, e.g., three or more changes. For example, are the names in a first data set of the sequence the same as in a second set of data in the sequence or is the social profile link the same. Step S4. If one of the authored-content documents is identified as being above the threshold, the identified authored-content document is removed or blacklisted from the authored-content database 105. Step S5. If one of the authored-content documents is identified as being below the threshold, the document is maintained in the authored-content database 105.

In another example, a crawling and indexing system can implement a processing framework 180, e.g., a MapReduce framework to gather information from an annotator 112 associated with the crawler 110. The framework 180 can be any software framework that processes massive amounts of unstructured data in parallel across a distributed cluster of processors or stand-alone computers. This information can be shared with a heuristic process for determining if a web document contains any authored content. If a determination is made that a document contains authored content, the document is indexed within an authored-content database 105.

The processing framework 180 can, also, over time gather updated authorship information. This authorship information can be obtained from the annotator 112 where the annotator analyzes annotations for a particular document, e.g., authored-content documents that were previously indexed within the authored content database. These successive framework processes process the annotations and update a historical representation of authorship data for each authored-content document. That is, the author history encodes a set of authorship data for each document at each time interval. The authorship data can include multiple fields, e.g., author name, link URL, profile ID, etc. The data used can be the most recent data available rather than having strict sequential dependencies. For example, a day can occasionally be skipped if timings are too far off, but most of the time the same change will simply be detected the next day and impact will be minimal. The successive framework processes can also inspect the annotations and find the current author(s) indicated by the annotations and compares these to the previous history entry for the URL. If the author set has changed, a new event is added to the history, otherwise no change is made.

The framework processes can also take the current history and quantifies the number of qualifying changes in the authorship data for a given authored-content document. Multiple updates can be used to form a reputation for instability for a specific document, therefore a time cutoff can be implemented in which older changes are ignored, e.g., all changes before the last 60 days. This ensures any transient changes will eventually expire from being considered. This quantification is set against a threshold to produce a set of authored-content pages to be black-listed if the change exceeds the set threshold. In other words, an algorithm, counts the number of qualifying authorship-data changes, which is compared to a threshold to determine if a document should be black-listed. This threshold can be three or more qualifying authorship-data changes. A qualifying authorship-data change can be a transition from one day to the next where, when comparing the authorship data sets for at least two days, at least one authorship data in one set has no equivalent in the other set sharing a common name, profile id, or linked author profile page.

Any black-listed document can be manually overridden in a white-listed table, for example, if a webmaster is experimenting with different configurations for a webpage and changes to the document are not associated with authored content, the document can be white-listed. The black-listed documents can be combined with white-listed documents in a single table where the white-listed documents override any determination of a document being black-listed. The resultant table contains a combined black-list table.

When an annotator is updating a document's history, the annotator can encounter a black-listed document, in this case, the system can still create authorship data for the black-listed document but can use a different designation for the document. For example, a non-black-listed document can be indexed with tag marked AUTHOR while a black-listed document can be indexed with tag marked BLACKLISTED_PAGE_AUTHOR. This indicates that the annotations can be considered to determine an author for the black-listed document but the document should not be indexed as an authored-content document. In one implementation, to keep the black-list table relatively compact, black-listing is only output for documents that have had at least one change, and where there was at least one author encountered in its history.

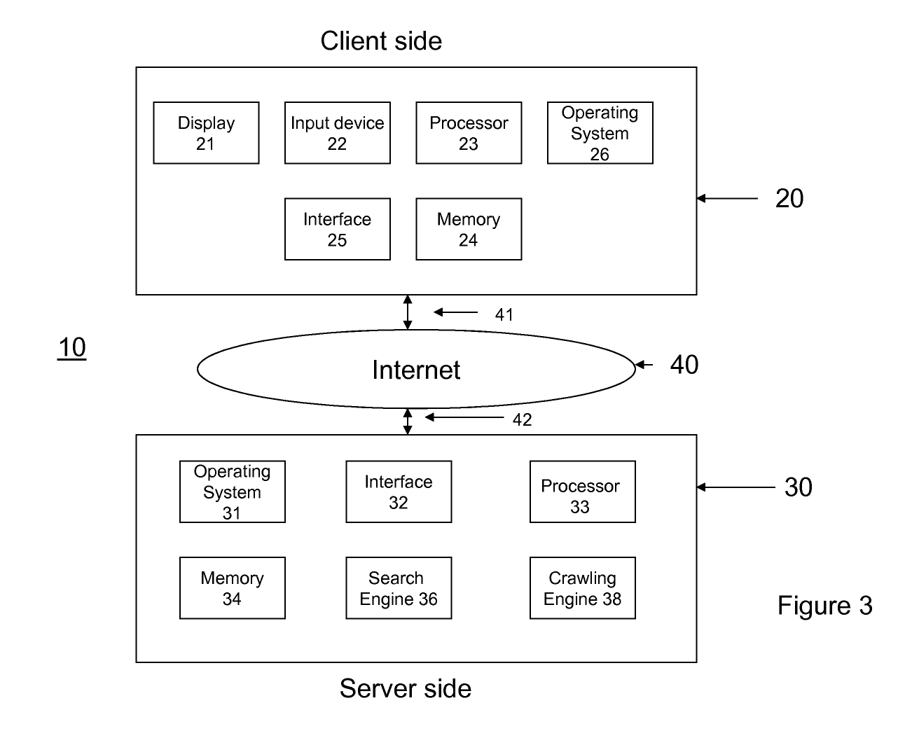

FIG. 3 is a schematic diagram of an example of a search system 10. The system 10 includes one or more processors 23, 33, one or more display devices 21, e.g., CRT, LCD, one or more interfaces 25, 32, input devices 22, e.g., keyboard, mouse, touch screen, etc., a crawling engine 38, a search engine 36, and one or more computer-readable mediums 24, 34. These components exchange communications and data using one or more buses 41, 42, e.g., EISA, PCI, PCI Express, etc.

The term “computer-readable medium” refers to any non-transitory medium 24, 34 that participates in providing instructions to processors 23, 33 for execution. The computer-readable mediums 24, 34 further include operating systems 26, 31 with network communication code, crawling code, indexing code, annotating code, searching code, analyzing code, and other program code.

The operating systems 26, 31 can be multi-user, multiprocessing, multitasking, multithreading, real-time and the like. The operating systems 26, 31 can perform basic tasks, including but not limited to: recognizing input from input devices 22; sending output to display devices 21; keeping track of files and directories on computer-readable mediums 24, 34, e.g., memory or a storage device; controlling peripheral devices, e.g., disk drives, printers, etc.; and managing traffic on the one or more buses 41, 42.

The network communications code can include various components for establishing and maintaining network connections, e.g., software for implementing communication protocols, e.g., TCP/IP, HTTP, Ethernet, etc.

The analyzing code can provide various software components for performing the various functions of analyzing authorship histories. The crawling and indexing code can provide various software components for performing the various functions of crawling and indexing Internet documents. The searching code can provide various software components for performing the various functions of searching data repositories or data indexes for information related to search queries.

Moreover, as will be appreciated, in some implementations, the system of FIG. 3 is split into a client-server environment communicatively connected over the Internet 40 with connectors 41, 42, where one or more server computers 30 include hardware as shown in FIG. 3 and also the crawling code, code for searching and indexing data on a computer network, and code for annotating, and where one or more client computers 20 include hardware as shown in FIG. 3 and also the analyzing code and the processing code, which can be pre-installed or delivered in response to a command.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage media for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be, or be included in, a computer-readable storage device, a computer-readable storage substrate, a random or serial access memory array or device, or a combination of one or more of them.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or combinations of them. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, e.g., a virtual machine, or a combination of one or more of them. The apparatus and execution environment can realize various different computing model infrastructures, e.g., web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program can, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on mobile phones, smart phones, tablets, personal digital assistants, and computers having display devices, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, tactile feedback, etc.; and input from the user can be received in any form, including acoustic, speech, tactile input, etc. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network, e.g., the Internet, and peer-to-peer networks, e.g., ad hoc peer-to-peer networks.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page to a client device, e.g., for purposes of displaying data to and receiving user input from a user interacting with the client device. Data generated at the client device, e.g., a result of the user interaction can be received from the client device at the server.

While this specification contains many specific implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. In some cases, the actions recited in the claims can be performed in a different order and still achieve desirable results. Moreover, the separation of various system components in the embodiments described above should not be understood as requiring such separation in all embodiments, and it should be understood that the described program components and systems can generally be integrated together in a single software product or packaged into multiple software products.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A computer-implemented method comprising the steps of:
recording a sequence of authorship data for at least one authored-content document over a period of time, the at least one authored-content document being indexed in an authored-content database;
analyzing the sequence of authorship data to determine if the at least one authored-content document changed beyond a set threshold;
removing the at least one authored-content document from the authored-content database if the at least one authored-content document is changed beyond the set threshold.

2. The computer-implemented method of claim 1 further comprising the step of:
comparing a first data set of the sequence of authorship data to a second data set of the sequence of authorship data; and
quantifying data changes between the first data set and the second data set.

3. The computer-implemented method of claim 2 further comprising the step of:
applying the quantified data changes to the set threshold.

4. The computer-implemented method of claim 3 wherein the set threshold is three or more changes within a defined time period.

5. The computer-implemented method of claim 1 wherein the sequence of authorship data includes at least one author name and information relating to a location of an author profile page.

6. The computer-implemented method of claim 1 further comprising the step of:
indexing the at least one authored-content document for the authored-content database.

7. The computer-implemented method of claim 1, wherein the period of time is once a day for a month.

8. A system comprising:
one or more processors;
one or more computer-readable storage mediums containing instructions configured to cause the one or more processors to perform operations including:
recording a sequence of authorship data for at least one authored-content document over a period of time, the at least one authored-content document being indexed in an authored-content database;
analyzing the sequence of authorship data to determine if the at least one authored-content document changed beyond a set threshold;
removing the at least one authored-content document from the authored-content database if the at least one authored-content document is changed beyond the set threshold.

9. The system of claim 8 further comprising the step of:
comparing a first data set of the sequence of authorship data to a second data set of the sequence of authorship data; and
quantifying data changes between the first data set and the second data set.

10. The system of claim 9 further comprising the step of:
applying the quantified data changes to the set threshold.

11. The system of claim 10 wherein the set threshold is three or more changes within a defined time period.

12. The system of claim 8 wherein the sequence of authorship data includes at least one author name and information relating to a location of an author profile page.

13. The system of claim 8 further comprising the step of:
indexing the at least one authored-content document for the authored-content database.

14. The system of claim 8 wherein the period of time is once a day for a month.

15. A computer-program product, the product tangibly embodied in a machine-readable storage medium, including instructions configured to cause a data processing apparatus to:
record a sequence of authorship data for at least one authored-content document over a period of time, the at least one authored-content document being indexed in an authored-content database;
analyze the sequence of authorship data to determine if the at least one authored-content document changed beyond a set threshold;
remove the at least one authored-content document from the authored-content database if the at least one authored-content document is changed beyond the set threshold.

16. The computer-program product of claim 15 further including instructions configured to cause a data processing apparatus to:
compare a first data set of the sequence of authorship data to a second data set of the sequence of authorship data; and
quantify data changes between the first data set and the second data set.

17. The computer-program product of claim 16 further including instructions configured to cause a data processing apparatus to:
applying the quantified data changes to the set threshold.

18. The computer-program product of claim 17 wherein the set threshold is three or more changes within a defined time period.

19. The computer-program product of claim 15 wherein the sequence of authorship data includes at least one author name and information relating to a location of an author profile page.

20. The computer-program product of claim 15 further including instructions configured to cause a data processing apparatus to:
indexing the at least one authored-content document for the authored-content database.

21. The computer-program product of claim 15 wherein the period of time is once a day for a month.
